(19) United States
(12) Patent Application Publication
(10) Pub. No.: US 2024/0418253 A1
(43) Pub. Date: Dec. 19, 2024

(54) METHOD FOR MANUFACTURING A TRANSMISSION DEVICE COMPRISING A ROTARY PART ROTATABLY GUIDED INSIDE A CASING

(71) Applicant: VALEO EMBRAYAGES, Amiens (FR)

(72) Inventor: Roël VERHOOG, Amiens (FR)

(73) Assignee: VALEO EMBRAYAGES, Amiens (FR)

(21) Appl. No.: 18/701,473

(22) PCT Filed: Oct. 27, 2022
(86) PCT No.: PCT/EP2022/080125

§ 371 Date: Apr. 15, 2024

(30) Foreign Application Priority Data
Oct. 27, 2021 (FR) FR21 11440

(51) Int. Cl. F16H 57/021; F16C 19/49; F16H 57/02; F16H 57/023; F16H 57/029; F16H 57/031; F16H 57/04

(52) U.S. Cl. CPC F16H 57/021; F16C 19/49; F16H 57/023; F16H 57/029; F16H 57/031; F16H 57/0424; F16C 2226/00; F16C 2229/00; F16C 2361/65; F16H 2057/02026; F16H 2057/02052

(57) ABSTRACT

A method for manufacturing a transmission device that includes a casing, and a rotary part rotatably guided inside the casing by means of a first bearing and a second bearing. The method includes axially moving a preloading element in a first recess until it bears axially against the first bearing in the first direction, and then applying a force to the preloading element until the applied force reaches a set value and the preloading element reaches a preloading position in which a predetermined axial preloading force is applied by the preloading element and the axial bearing surface of the casing to the first bearing and the second bearing, respectively. The preloading element is attached to the casing in in the preloading position.

### TECHNICAL FIELD

The invention relates to the field of transmission devices for a drivetrain of a mobility apparatus, such as a motor vehicle, for example.

It relates to a method for manufacturing a transmission device comprising a casing and at least one rotary part, such as a shaft, rotatably guided by rolling bearings inside said casing.

The invention also relates to a transmission device obtained by such a method.

### TECHNOLOGICAL BACKGROUND

Document US2019003526 discloses a reduction device which comprises shafts equipped with toothed wheels. The reduction device comprises a casing comprising at least two parts attached to each other and defining an inner space in which the shafts are housed. The shafts are each rotatably mounted on the casing via a pair of rolling bearings. Each rolling bearing comprises an outer ring, an inner ring and rolling bodies interposed between the outer ring and the inner ring. The inner rings are each fitted onto an inner bearing surface formed at one of the ends of one of the shafts and bearing in the direction of the other end of said shaft against an axial bearing surface. The outer rings of each pair of rolling bearings are respectively mounted in a housing formed in each of the two parts of the casing. The housings have a cylindrical shape and thus form an outer bearing surface for the rolling bearings.

The housings formed in one of the two parts of the casing are closed by a shim plate. In addition, shims of variable thickness are arranged between the shim plate and the outer rings of the adjacent rolling bearings. The shims thus aim to mount the shafts in rotation on the casing without axial play in order to limit noise and vibration. More particularly, the thicknesses of the shims are chosen so that the shim plate exerts a satisfactory axial preload on each of the rolling bearings via the shims, that is to say a preload which is sufficient to reduce noise and vibration of the rolling bearings and shafts but without being excessive so as not to significantly increase the drag torque of the reduction device.

Such a reduction device is not fully satisfactory. In particular, the use of shims to preload rolling bearings requires long and complex measuring operations and also requires a set of shims of different thicknesses being made available to operators, which even further complicates manufacturing operations and increases the risk of noncompliance.

### SUMMARY

An idea underlying the invention is therefore to propose a method for manufacturing a transmission device comprising a rotary part rotatably guided in a casing that solves the aforementioned drawbacks, that is to say which is simple and which makes it possible to limit or avoid noise and vibration likely to be generated by positioning clearances between the rotary part and the bearings due to manufacturing tolerances of the components of the transmission device and/or phenomena of thermal contraction or expansion of the elements of the transmission device.

To achieve this, according to a first aspect, the invention provides a method for manufacturing a transmission device, the transmission device comprising a casing comprising at least a first part and a second part attached to each other and defining an inner space, the first part and the second part comprising a first housing and a second housing, respectively, the first and second housings comprising a first and a second outer bearing surface, respectively, the first part having an opening which opens into the first housing and the second part of the casing being equipped with an axial bearing surface bordering the second outer bearing surface; the transmission device further comprising a rotary part comprising a first and a second inner bearing surface; the first and second inner bearing surfaces of the rotary part being respectively fitted into a first bearing and a second bearing, the first bearing being mounted in the first housing and the second bearing being mounted in the second housing such that the first bearing is mounted radially between the first inner bearing surface and the first outer bearing surface and the second bearing is mounted radially between the second inner bearing surface and the second outer bearing surface; the first bearing and the second bearing being blocked axially with respect to said rotary part respectively in at least a first direction and a second direction opposite to said first direction;

the method comprising the following successive steps:
axially moving a preloading element in the first housing until it bears axially, directly or indirectly, against the first bearing in the first direction;
applying a force to the preloading element so as to continue the axial movement of the preloading element with respect to the first part of the casing in the first direction until the applied force reaches a set value and the preloading element reaches a preloading position corresponding to said set value and in which a predetermined axial preloading force is applied by the preloading element and the axial bearing surface of the casing to the first bearing and the second bearing, respectively; and
attaching the preloading element to the casing in said preloading position.

Thus, the preloading element allows the first and second rolling bearings to be preloaded to an appropriate preloading value. This makes it possible to limit or avoid noise and vibration in a simple way, without requiring operations to measure the tolerances of the components of the transmission device.

According to embodiments, such a method may comprise one or more of the following features.

According to one embodiment, the preloading element is attached to the casing in said preloading position so as to withstand axial forces in the direction opposite to the preload that are greater than the preload, for example 1.5 to 15 times greater.

According to one embodiment, the preloading element is blocked on the casing in said preloading position.

According to one embodiment, the preloading element is blocked on the casing with fastening means distinct from the means applying the preload during the assembly process.

According to one embodiment, the preloading element is attached to the casing in a nonremovable manner.

Thus, the preloading element is locked on the casing even in the presence of large axial forces.

According to one embodiment, the preloading element is attached to the casing by means of a weld.

According to one embodiment, the preloading element is attached to the casing by assembly means such as screws or rivets.

According to one embodiment, the weld or the means for assembling the preloading element to the casing are capable of withstanding axial forces greater than the preload, for example 1.5 to 15 times greater.

For example, the weld or the means for assembling the preloading element to the casing are capable of withstanding axial forces greater than 1000 N, in particular greater than 1500 N, for example greater than 2000 N.

According to one embodiment, the opening of the first part is sealingly closed with a cover.

According to one embodiment, the cover forms the preloading element.

According to one embodiment, in the preloading position, the second bearing bears against the axial bearing surface in the first direction.

According to one embodiment, the preloading element is not in planar surface abutment, perpendicularly to the axis of rotation of the rotary part, against the casing when the preloading element is attached to the casing. This allows the preloading element to be able to be positioned with respect to the first part of the casing in a plurality of preloading positions corresponding to different preloading values.

Preferably, the preloading element is configured to be able to be attached to the first part of the casing, in the first housing, in a plurality of axial preloading positions.

According to one embodiment, when the force is applied to the preloading element, a value representative of said force is measured and the movement is stopped when the measured force is equal to the set value.

According to another embodiment, the method comprises a preliminary step of calibrating the equipment applying the force to the preloading element. This makes it possible to ensure that the force applied to the preloading element is equal to the set value without having to measure this force each time it is applied to the preloading element.

According to one embodiment, the preloading element is a cover and the cover is inserted into the opening so as to bear against the first bearing and close said opening, the force applied to the preloading element being directed to compress the first bearing, the rotary part and the second bearing between the cover and the axial bearing surface of the second part of the casing. Thus, the cover has a double functionality since it serves both to guarantee the sealing of the casing and to preload the bearings.

According to one embodiment, the cover is sealingly attached to the first part of the casing in the preloading position. Thus, the attachment of the cover has a double function, namely to ensure that the cover is held in its preloading position and to guarantee the tightness of the rigid connection of the cover to the casing.

According to one embodiment, the cover comprises a bottom wall and an annular skirt projecting axially from the bottom wall inside the first housing, the annular skirt bearing against the first bearing, preferably against the outer ring of the first bearing.

According to an advantageous embodiment, the annular skirt has a shape complementary to that of the first housing

According to one embodiment, the cover is configured to damp vibrations agitating the rotary part.

According to one embodiment, the first part of the casing comprises an orifice which passes through the wall of the first part of the casing in the vicinity of the housing and the cover comprises one or more passages to allow oil to circulate from the orifice to the housing, the cover being inserted into the opening while making the passage and the orifice coincide.

According to one embodiment, the rotary part is a hollow shaft having an inner bore, the cover comprising a deflector projecting in the interior of the hollow shaft and thereby making it possible to deflect a fluid flow toward the interior of the inner bore.

According to one embodiment, the cover has an aperture, in particular a through-aperture, and supports a functional element selected from a temperature sensor, a drain plug, a magnet and an electrical connection device, said functional element being arranged in said aperture of the cover.

According to one embodiment, the cover has a guide element for guiding a wire or a pipe.

According to one embodiment, the preloading element is a sleeve which is interposed radially between the first outer bearing surface and the first bearing and which comprises an axial bearing surface which is positioned in abutment against the first bearing on a side opposite to the opening, the force applied to the preloading element being a tensile force exerted on the sleeve.

According to one embodiment, the method comprises a step of closing the opening with a cover.

According to one embodiment, the cover is sealingly welded to the casing.

According to one embodiment, the first bearing and the second bearing are rolling bearings each comprising an inner ring, an outer ring and rolling bodies interposed between the inner ring and the outer ring.

According to one embodiment, the preloading element bears against the outer ring of the first bearing.

According to one embodiment, the method comprises a step of machining the first and second outer bearing surfaces, said machining step involving connecting the first part and the second part of the casing and then inserting a machining tool into the inner space through the opening of the first part and machining the first and second outer bearing surfaces with said machining tool. Such machining of the outer bearing surfaces makes it possible to eliminate or limit misalignments, which contributes to even further reducing noise and vibration.

According to one embodiment, the rotary part is a shaft of a reduction device, the shaft comprising one or two toothed wheels.

According to one embodiment, the rotary part is an input shaft of a reduction device, said input shaft being intended to be coupled to a motor.

According to one embodiment, the rotary part is an intermediate shaft of a reduction device, the intermediate shaft comprising a first toothed wheel intended to be driven in rotation by a motor and a second toothed wheel meshing with a toothed wheel of a differential device.

According to one embodiment, the rotary part is a differential housing, the differential housing being rotationally coupled, directly or via a coupling device, to a toothed wheel, two planet gears being mounted to rotate inside the differential housing about an axis of rotation perpendicular to the axis of rotation of the differential housing, two sun gears being rotatable inside the differential housing about the axis of rotation of the differential, the two sun gears each comprising bevel gear teeth which mesh with complementary bevel gear teeth of the two planet gears, the sun gears each being intended to be rotationally secured to one of the two half-shafts of an axle of a vehicle.

According to one embodiment, the transmission device comprises a plurality of rotary parts mounted so as to be guided in rotation by a pair of bearings inside the casing, the pair of bearings of a plurality of or all of the rotary parts being preloaded by means of a preloading element mounted on the casing according to the aforementioned method.

According to a second aspect, the invention provides a transmission device comprising:
a casing comprising at least a first part and a second part attached to each other and defining an inner space, the first part and the second part comprising a first housing and a second housing, respectively, the first and second housings comprising a first and a second outer bearing surface, respectively, the first part having an opening which opens into the first housing and the second part of the casing being equipped with an axial bearing surface bordering the second outer bearing surface;
a rotary part comprising a first and a second inner bearing surface respectively fitted into a first bearing and a second bearing, the first bearing being housed in the first housing and the second bearing being housed in the second housing such that the first bearing is mounted radially between the first inner bearing surface and the first outer bearing surface and the second bearing is mounted radially between the second inner bearing surface and the second outer bearing surface; the first bearing and the second bearing being blocked axially with respect to said rotary part respectively in at least a first direction and a second direction opposite to said first direction;
a preloading element configured to be able to be attached to the first part of the casing, in the first housing, in a plurality of preloading positions in which the preloading element exerts an axial preload on the first bearing in the first direction and the axial bearing surface of the second housing exerts an axial preload on the second bearing in the second direction; each preloading position corresponding to a different axial preloading value.

In other words, the preloading element has a structure such that, before being attached to the first part of the casing, it can assume a plurality of relative positions with respect to the first part of the casing.

According to one embodiment, the axial preloading value increases with the relative movement of the preloading element with respect to the first part of the casing in the first direction.

According to one embodiment, the device has no planar surface contact, perpendicularly to the axis of rotation of the rotary part, between the preloading element and the first part of the casing.

According to one embodiment, the preloading element is a cover which is inserted into the opening so as to close said opening.

According to one embodiment, the preloading element is a sleeve which is interposed radially between the first outer bearing surface and the first bearing and which comprises an axial bearing surface which is positioned in abutment against the first bearing on a side opposite to the opening.

According to one embodiment, the device comprises a cover closing the opening.

According to one embodiment, the cover comprises an annular skirt ensuring both the sealed closure of the opening and the preloading force.

According to one embodiment, the opening is larger than the first bearing and the housing.

According to one embodiment, the cover comprises a first axial sealing skirt for sealingly closing the opening and a second axial preloading skirt, the second axial preloading skirt being situated radially inside the first axial sealing skirt.

According to one embodiment, the first part of the casing comprises an orifice situated radially between the housing and an edge of the opening and the cover comprising one or more passages connecting the orifice and the housing.

### BRIEF DESCRIPTION OF THE FIGURES

The invention will be better understood, and other aims, details, features and advantages thereof will become more clearly apparent, from the following description of several particular embodiments of the invention, given solely by way of illustration and without limitation, with reference to the appended drawings.

FIG. 1 is a perspective view of a casing of a transmission device.

FIG. 2 is a perspective view of the components of a transmission device which are intended to be housed in the casing of FIG. 1 according to one embodiment.

FIG. 3 is a sectional view of the casing of FIG. 1 passing through two housings intended to house rolling bearings guiding in rotation one of the shafts of the transmission device.

FIG. 4 is a schematic sectional view of a casing in which a shaft guided in rotation by two rolling bearings is housed.

FIG. 5 is a schematic sectional view of a housing in which a rolling bearing is housed and of a cover, according to a first embodiment, which closes said housing and which exerts an axial preload on the rolling bearing.

FIG. 6 is a schematic view analogous to that of FIG. 5 and illustrating a second embodiment.

FIG. 7 is a schematic sectional view of a casing inside which a shaft is guided in rotation by three rolling bearings.

FIG. 8 is a schematic view analogous to that of FIGS. 5 and 6 and illustrating a third embodiment.

FIG. 9 is a schematic view analogous to that of FIGS. 5, 6 and 8 and illustrating a fourth embodiment.

FIG. 10 is a schematic view analogous to that of FIGS. 5, 6, 8 and 9 and illustrating a fifth embodiment.

### DESCRIPTION OF THE EMBODIMENTS

In the description and the claims, the terms “outer” and “inner” as well as the orientations “axial” and “radial” will be used to designate, according to the definitions given in the description, elements of the transmission device. By convention, the axes of rotation of the rotary parts of the transmission device define the “axial” orientation. The “radial” orientation is directed orthogonally to the axis in question and, from the inside toward the outside, away from the axis of rotation of the rotary part in question. The terms “outer” and “inner” are used to define the relative position of one element with respect to another, with reference to the axis of rotation in question, an element close to the axis thus being referred to as “inner” as opposed to an outer element situated radially at the periphery.

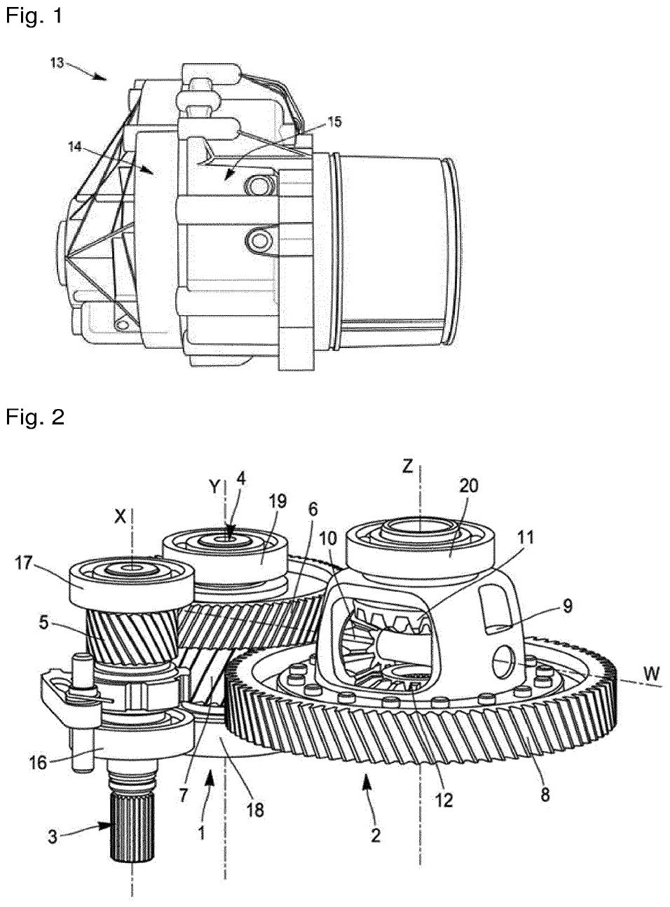

With reference to FIGS. 1 to 3, a transmission device comprising a reduction device 1 and a differential device 2 is described. In the embodiment shown, the transmission device is intended for a motor vehicle. More particularly, the reduction device 1 is intended to transmit a torque with a transmission ratio of less than 1 between an electric motor, not shown, and the differential device 2, in order to increase the torque delivered by the electric motor.

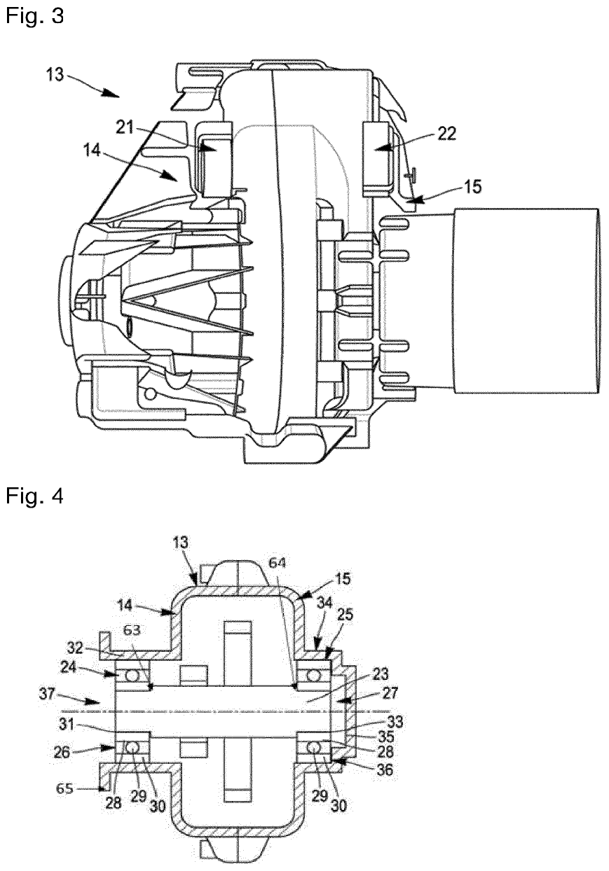

As shown in FIG. 2, the reduction device 1 comprises an input shaft 3 which is intended to be coupled in rotation to the motor and an intermediate shaft 4. The input shaft 3 and the intermediate shaft 4 are intended to be rotatably mounted on the casing 13, shown in FIGS. 1 and 3, respectively about an axis X and an axis Y, which are parallel to each other. The input shaft 3 comprises a toothed wheel 5 and the intermediate shaft 4 comprises two toothed wheels 6, 7. The toothed wheel 5 of the input shaft 3 meshes with one of the toothed wheels 6 of the intermediate shaft 4, while the other toothed wheel 7 of the intermediate shaft 4 meshes with a toothed wheel 8 of a differential device 2. The toothed wheel 8 of the differential device 2 is rotatable about an axis Z, parallel to the axes X and Y. Furthermore, the differential device 2 comprises a differential housing 9 which is also rotatable about the axis Z and which is coupled in rotation to the toothed wheel 8 of the differential device 2. The differential device 2 also comprises two planet gears 10—only one of which is visible in FIG. 2—which are mounted to rotate on the differential housing 9 about an axis W, perpendicular to the axis X, as well as two sun gears 11, 12. The two sun gears 11, 12 each comprise bevel gear teeth which mesh with complementary bevel gear teeth of the two planet gears 10. Moreover, the two sun gears 11, 12 are rotatable about the axis Z and each comprise a splined hub intended to be secured in rotation to one of the two half-shafts, not shown, of an axle of the vehicle. Thus, the differential device 2 makes it possible to distribute the torque coming from the electric motor to the two half-shafts, allowing the two half-shafts to rotate at different speeds.

According to an embodiment that is not shown, the toothed wheel 8 and the differential housing 9 are coupled to each other by a coupling device which has, on the one hand, a coupled position in which it allows a transmission of torque between the toothed wheel 8 and the differential housing 9 and, on the other hand, a decoupled position in which the transmission of the torque between the toothed wheel 8 and the differential housing 9 is interrupted.

As shown in FIGS. 1 and 3, the casing 13 of the reduction device 1 comprises at least two parts, namely a first part 14 and a second part 15 intended to be attached to each other and defining an inner space 16 in which the reduction device 1 and the differential device 2 are housed.

The rotary parts of the transmission device, namely the input shaft 3, the intermediate shaft 4 and the differential housing 9 are each equipped with a pair of rolling bearings 16, 17, 18, 19, 20, shown in FIG. 2. The rolling bearings 16, 17, 18, 19, 20 of each pair are positioned in the vicinity of each of the ends of the input shaft 3, the intermediate shaft 4 or the differential housing 9, respectively. One of the rolling bearings 16, 18 of each pair is mounted in a housing of the first part 14 of the casing 13, while the other rolling bearing 17, 19, 20 is mounted in a housing of the second part 15 of the casing 13. In FIG. 3, only the housings 21, 22 intended to receive the rolling bearings 18, 19 guiding the intermediate shaft 4 in rotation are shown.

FIG. 4 schematically shows the casing 13, a shaft 23 as well as the two rolling bearings 24, 25 guiding said shaft 23 in rotation and housed in a housing 26, 27 of one or other of the two parts 14, 15 of the casing 13. The features of the rolling bearings 24, 25 and of the housings 26, 27 of the casing 13 which will be described below may apply to the rotational guidance of one, of a plurality of or all of the three rotary parts described above, namely the input shaft 3, the intermediate shaft 4 and the differential housing 9.

As shown in FIG. 4, each rolling bearing 24, 25 comprises an inner ring 28, an outer ring 30 and rolling bodies 29 interposed between the inner ring 28 and the outer ring 30. The rolling bodies 29 here are balls but may also be rollers or needles in particular. The inner ring 28 of each of the rolling bearings 24, 25 is fitted onto an inner bearing surface 31, 33 formed at one of the ends of the shaft 23. In the embodiment shown, each inner bearing surface 31, 33 is delimited in the direction of the other end of the shaft 23 by a shoulder 63, 64. Each shoulder 63, 64 thus defines an axial bearing surface against which the inner ring 28 of the rolling bearing 24, 25 abuts. In another embodiment that has not been shown, the inner rings 28 are mounted clamped in a predetermined position on the shaft 23, which prevents the axial movement of the rolling bearings 24, 25 along the shaft 23. The rolling bearings are therefore blocked axially on the shaft 23 at least in one direction.

Each of the two parts 14, 15 of the casing 13 comprises a housing 26, 27 intended to house one of the two rolling bearings 24, 25. Each of the housings 26, 27 comprises an outer bearing surface 32, 34 in the form of a cylinder of revolution. The housing 27 of the part 15 of the casing 13 comprises a bottom 35 as well as a shoulder which borders the outer bearing surface 32 on the side opposite to the inner space of the casing 13. The shoulder thus defines an axial bearing surface 36 against which the outer ring 30 of the rolling bearing 25 is intended to come into abutment. The other part 14 of the casing 13 comprises an opening 37 which passes through the casing 13 and which opens into the housing 26. In the embodiment shown, the opening 37 has a diameter substantially equal to that of the outer bearing surface 32 of the housing 26.

Such an opening 37 is particularly advantageous in several respects. This opening 37 is used in particular during the machining of the outer bearing surfaces 32, 34 of the housings 26, 27 of the two parts 14, 15 of the casing 13. For this purpose, the two parts 14, 15 of the casing 13 are assembled together without the other components and in particular the shaft 23 and the two rolling bearings 24, 25 are not present in the inner space of the casing 13. A machining tool is then introduced through the opening 37 in order to machine the two outer bearing surfaces 32, 34 of the two housings 26, 27 during the same machining operation. Such an implementation of the operations of machining the outer bearing surfaces 32, 34 makes it possible to eliminate or at least limit misalignments between the outer bearing surfaces 32, 34 of the two housings 26, 27. Moreover, as explained in greater detail below, this opening 37 also makes it possible to facilitate the operations aimed at axially preloading the rolling bearings 24, 25.

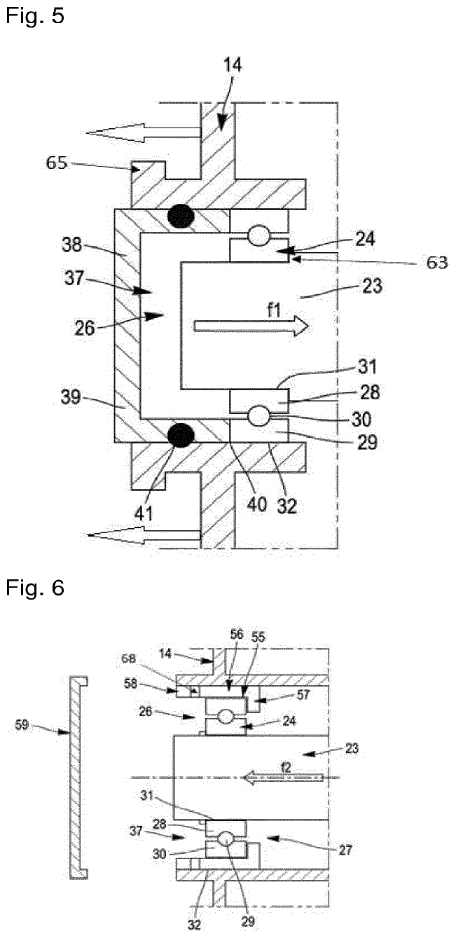

In the embodiment shown in FIG. 5, a cover 38 is inserted into the opening 37 in order to seal the casing 13. The cover 38 also has a second functionality, namely to preload the rolling bearings 24, 25. For this purpose, after having inserted the cover 38 into the opening 37 and having positioned it in abutment against the rolling bearing 24, and more particularly against its outer ring 30, an axial force is applied to the cover 38 while a retaining force is applied to the casing 13 so that the cover 38 moves axially with respect to the casing 13 in the direction corresponding to the arrow f1 in FIG. 5. Thus, with the rolling bearing 24 being blocked axially at least in the direction f1 on the shaft 23, while the other rolling bearing 25 is blocked axially on the shaft 23 in a direction opposite to f1, the force exerted by the cover 38 on the inner ring 28 of the rolling bearing 24 in the direction f1 passes through the shaft 23 and the other rolling bearing 25 as far as the axial bearing surface 36 of the other housing 27. The latter then exerts a reaction force of opposite direction to f1 on the rolling bearing 25.

Advantageously, the retaining force is applied to the first part 14 of the casing 13 closest to the rolling bearing 24. Thus, in FIG. 5, the first part 14 of the casing comprises a collar 65 which is formed around the opening 37 and which thus allows a tool, such as a clamp, to be used to retain the first part 14 of the casing 13 in the vicinity of the rolling bearing 24 when a force is applied to the cover 38.

The cover 38 is moved until the applied force reaches a set value. The cover 38 thus assumes a preloading position which corresponds to the set value. In the preloading position, the rolling bearings 24, 25 and the shaft 23 are axially compressed between, on the one hand, the cover 38 and, on the other hand, the axial bearing surface 36 of the housing 27. The two rolling bearings 24, 25 are thus preloaded, which limits vibration. The cover 38 is then sealingly attached to the casing 13 in said preloading position, for example by a welding operation.

The set value is, for example, between 200 and 2000 N, preferably between 500 and 1500 N and, for example, of the order of 1000 N.

According to one embodiment, the force is applied to the cover 38 by a force-controlled press. Such a press comprises two elements which are movable with respect to each other and against which the cover 38 and the casing 13 respectively bear. To position the cover 38 in the preloading position, one of the two movable elements of the press is brought closer to the other by an actuator so as to move the cover 38 with respect to the casing 13 in the direction f1 until the force exerted by the actuator reaches the set value.

In the embodiment illustrated in FIG. 5, the cover 38 comprises a bottom wall 39 and an annular skirt 40 projecting perpendicularly to the bottom wall 39. The annular skirt 40 has a shape complementary to that of the housing 26. It thus fits into the housing 26. The cover 38 thus comes to bear against the outer ring 30 of the rolling bearing 24 via the free end of said annular skirt 40. In FIG. 5, a weld bead 41 is produced over the entire outer periphery of the annular skirt 40 so as to fix the cover 38 in the preloading position and to sealingly connect the annular skirt 40 to the outer bearing surface 32 of the housing 26. The same annular skirt 40 here ensures the sealed closure of the opening 37 and the preloading force on the rolling bearing 24.

According to another embodiment that is not illustrated, the annular skirt 40 has a thread and the housing 26 has a complementary tapping. Thus, the cover 38 is screwed into the housing 26 until a threshold screwing torque is reached which is representative of the set value of the axial force to be applied by the cover 38 against the rolling bearing 24.

FIG. 8 shows a cover 42 according to another embodiment. This embodiment differs from the preceding embodiment in that the cover 42 has yet another functionality: namely to provide an oil circuit inside the housing 26. In FIG. 8, the arrows schematically represent the circulation of the oil in the housing 26.

In the embodiment shown, the opening 37 is larger than the first rolling bearing 24 and the housing 26.

The cover 42 here comprises a first axial sealing skirt 71 for sealingly closing the opening 37 and a second axial preloading skirt 40. The second axial preloading skirt 72 is situated radially inside the first axial sealing skirt 71.

The first part 14 of the casing 13 comprises an orifice 43 which passes through the wall of the first part 14 of the casing 13 in the vicinity of the housing 26.

Advantageously, the orifice 43 is situated above the housing 26, which makes it possible to circulate the oil from the orifice 43 to the housing 26 by gravity. The orifice 43 is situated radially between the housing 26 and the edge of the opening.

The cover 42 comprises one or more passages 44 allowing the oil to circulate from the orifice 43 to the housing 26. More particularly, a passage 44 is formed in the second axial preloading skirt 40 of the cover 42. The passage 44 connects the orifice 43 and the housing 26.

It can also be seen that the shaft 23 is hollow and thus has an inner bore 46 which is formed in the longitudinal direction of the shaft 23. The inner bore 46 allows oil to circulate through the shaft 23. In addition, the cover 42 comprises a deflector 45 which projects axially, from the bottom wall 39, inside the inner bore 46 of the shaft 23. The deflector 45 thus allows the flow of oil coming from the orifice 43 to be deflected toward the inner bore 46 of the shaft 23.

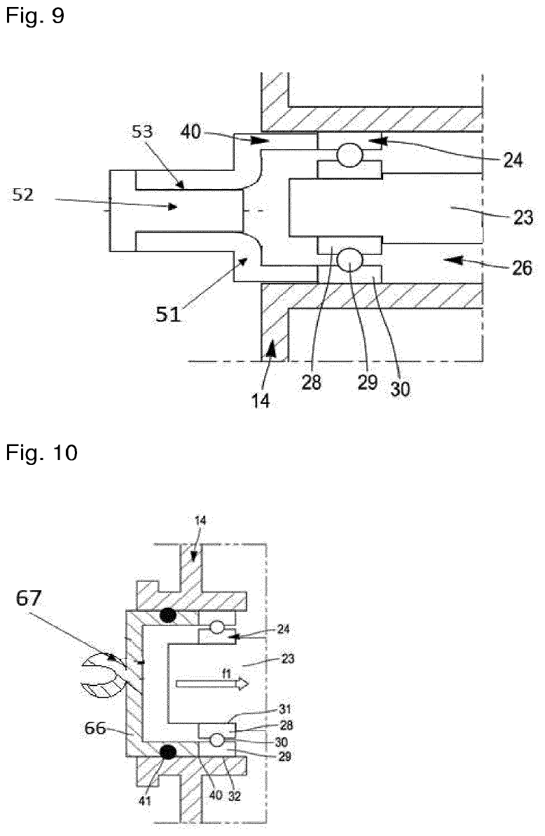

FIG. 9 illustrates a cover 51 according to another embodiment. This embodiment differs from the embodiment of FIG. 5 in that the cover 51 has an additional functionality, namely a function of supporting a functional element 52 of the transmission device. The functional element 52 supported by the cover 51 may be, in particular, a temperature sensor, a drain plug, a magnet having the function of capturing metal debris present inside the casing 13 or an electrical connection device, for example intended to be connected to an electric actuator arranged inside the casing 13. As shown in FIG. 9, the cover 51 comprises an aperture 53 through which the functional element 52 is fitted.

FIG. 10 illustrates a cover 66 according to yet another embodiment. In this embodiment, the cover 66 has, on the outer face of its bottom wall, a guide element 67 for guiding a wire, such as a wire intended to electrically power an actuator or a sensor of the transmission device, or for guiding a pipe, such as a pipe of a coolant circuit.

FIG. 6 illustrates yet another embodiment. This embodiment differs from the embodiments described above in that the preloading of the rolling bearings 24, 25 is not achieved by the cover 54 closing the opening 37 which opens into the housing 26 but by a dedicated preloading element 55.

In this embodiment, the preloading element 55 comprises a sleeve 56 which is arranged radially between the outer ring 30 of the rolling bearing 24 and the outer bearing surface 32 of the first housing 26. The sleeve 56 comprises a shoulder 57 which is positioned in abutment against the rolling bearing 24, and more particularly against the edge of the outer ring 30 of the rolling bearing 24 that is opposite to the opening 37. The sleeve 56 also comprises a portion 58 which projects beyond the edge of the outer ring 30 closest to the opening 37.

In this embodiment, a tensile force is exerted on the preloading element 55 in the direction represented by the arrow f2. Thus, the preloading element 55 moves axially with respect to the casing 13 in the direction f2 until the tensile force reaches a set value. According to the embodiment shown, the portion 58 of the sleeve 56 comprises radial holes 68 which are intended to receive fingers of a pulling tool.

In such an embodiment, the rolling bearing 24 is blocked axially on the shaft 23 in the direction f2, for example by means of a circlip 69. Similarly, the other rolling bearing 25 is blocked axially on the shaft 23 in the direction f1 opposite to the direction f2. In addition, the other housing 27 comprises an axial bearing surface 36 which, with respect to the embodiment shown in FIG. 4, is positioned on the other side of the rolling bearing 25. Thus, the tensile force exerted on the rolling bearing 24 by the preloading element 55 passes through the shaft 23 and the other rolling bearing 25 and is taken up by the axial bearing surface 36 of the other housing 27. The axial bearing surface 36 then exerts a reaction force of opposite direction to f2 on the rolling bearing 25. The two rolling bearings 24, 25 are thus preloaded axially by the preloading element 55. The preloading element 55 is fixed axially with respect to the casing 13 in said preloading position. The preloading element 55 is, for example, welded to the outer bearing surface 32 of the housing 27. Thereafter, a cover 59 is arranged so as to close the opening 37 and is sealingly welded to the first part of the casing 13 all around the opening 37.

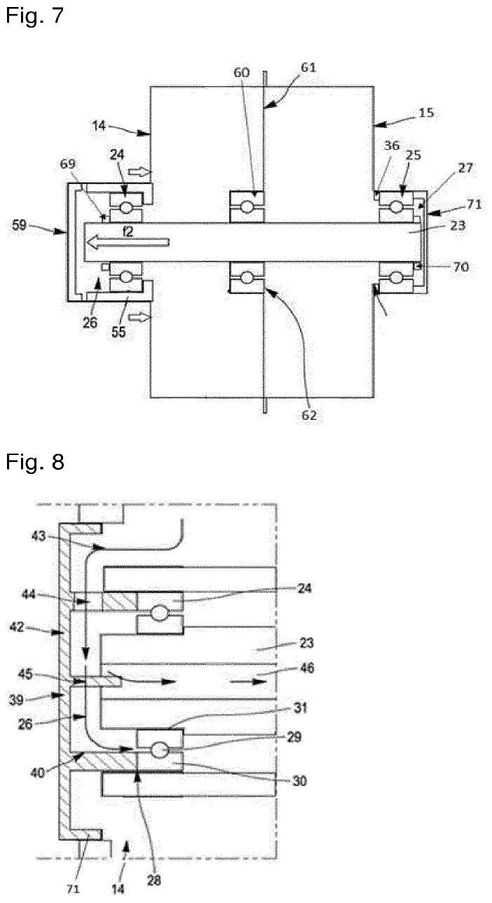

Such a preloading element 55 can in particular be used to preload two rolling bearings 24, 25 of a shaft 23 guided in rotation by three rolling bearings 24, 25, 60, as shown in FIG. 7.

In such a case, the casing 13 may, for example, comprise three parts 14, 15, 61 which are fixed to one another and each comprising a housing 26, 27, 62 intended to receive one of the three rolling bearings 24, 25, 60. The housing 27 of the part 15 of the casing 13 comprises an axial bearing surface 36 against which the outer ring 30 of the rolling bearing 25 is intended to come into abutment.

Thus, the rolling bearing 24 which is housed in the housing 26 arranged on the axial bearing surface 36 side is axially preloaded by means of a preloading element 55, as described above in relation to FIG. 6, which exerts a tensile force on said rolling bearing 24. This preloading element 55 also makes it possible to axially preload the rolling bearing 25 between the axial bearing surface 36 and an element 70, such as a circlip, axially blocking the rolling bearing 25 on the shaft 23 in a direction opposite to f2. A cover 70 is also inserted inside the housing 27 in order to close it.

The third rolling bearing 60 which is housed in the part 61 of the casing 13 arranged between the other two parts 15, 16 is for its part not preloaded axially, in the embodiment shown.

Although the invention has been described in conjunction with several particular embodiments, it is quite obvious that it is in no way limited thereto and that it covers all the technical equivalents of the means described and their combinations if they fall within the scope of the invention as defined by the claims.

The use of the verb “have”, “comprise” or “include” and its conjugated forms does not exclude the presence of elements or steps other than those set out in a claim.

In the claims, any reference sign between parentheses should not be interpreted as a limitation of the claim.

1. A method for manufacturing a transmission device, the transmission device comprising a casing comprising at least a first part and a second part attached to one another and defining an inner space, the first part and the second part comprising a first housing and a second housing, respectively, the first and second housings comprising a first and a second outer bearing surface, respectively, the first part having an opening which opens into the first housing and the second part of the casing being equipped with an axial bearing surface bordering the second outer bearing surface; the transmission device further comprising a rotary part comprising a first and second inner bearing surface; the first and second inner bearing surfaces of the rotary part being fitted into a first bearing and a second bearing, respectively, the first bearing being mounted in the first housing and the second bearing being mounted in the second housing such that the first bearing is mounted radially between the first inner bearing surface and the first outer bearing surface and the second bearing is mounted radially between the second inner bearing surface and the second outer bearing surface; the first bearing and the second bearing being blocked axially with respect to said rotary part respectively in at least a first direction and a second direction opposite to said first direction;
the method comprising the following successive steps:
axially moving a preloading element in the first housing until it bears axially against the first bearing in the first direction;
applying a force to the preloading element so as to continue the axial movement of the preloading element with respect to the first part of the casing in the first direction until the applied force reaches a set value and the preloading element reaches a preloading position corresponding to said set value and in which a predetermined axial preloading force is applied by the preloading element and the axial bearing surface of the casing to the first bearing and the second bearing, respectively; and
attaching the preloading element to the casing in said preloading position.

2. The manufacturing method as claimed in claim 1, wherein the preloading element is a cover and wherein the cover is inserted into the opening so as to bear against the first bearing and close said opening; and wherein the force applied to the preloading element is directed to compress the first bearing, the rotary part and the second bearing between the cover and the axial bearing surface of the second part of the casing.

3. The manufacturing method as claimed in claim 2, wherein the cover is sealingly attached to the first part of the casing in the preloading position.

4. The manufacturing method as claimed in claim 2, wherein the first part of the casing comprises an orifice which passes through the wall of the first part of the casing in the vicinity of the housing and the cover comprises one or more passages to allow oil to circulate from the orifice to the housing, the cover being inserted into the opening while making the passage and the orifice coincide.

5. The manufacturing method as claimed in claim 2, wherein the cover has an aperture and wherein the cover supports a functional element selected from a temperature sensor, a drain plug, a magnet and an electrical connection device, said functional element being arranged in said aperture of the cover.

6. The manufacturing method as claimed in claim 2, wherein the cover further has a guide element for guiding a wire or a pipe.

7. The manufacturing method as claimed in claim 1, wherein the preloading element is a sleeve which is interposed radially between the first outer bearing surface and the first bearing and which comprises an axial bearing surface which is positioned in abutment against the first bearing on a side opposite to the opening and wherein the force applied to the preloading element is a tensile force exerted on the sleeve.

8. The manufacturing method as claimed in claim 7, further comprising a step of closing the opening with a cover.

9. The manufacturing method as claimed in claim 1, wherein the first bearing and the second bearing are rolling bearings each comprising an inner ring, an outer ring and rolling bodies interposed between the inner ring and the outer ring.

10. The manufacturing method as claimed in claim 1, comprising a step of machining the first and second outer bearing surfaces, said machining step involving connecting the first part and the second part of the casing and then inserting a machining tool into the inner space through the opening of the first part and machining the first and second outer bearing surfaces with said machining tool.

11. A transmission device comprising:
a casing comprising at least a first part and a second part attached to each other and defining an inner space, the first part and the second part comprising a first housing and a second housing, respectively, the first and second housings comprising a first and a second outer bearing surface, respectively, the first part having an opening which opens into the first housing and the second part of the casing being equipped with an axial bearing surface bordering the second outer bearing surface;
a rotary part comprising first and second inner bearing surfaces respectively fitted into a first bearing and a second bearing, the first bearing being housed in the first housing and the second bearing being housed in the second housing such that the first bearing is mounted radially between the first inner bearing surface and the first outer bearing surface and the second bearing is mounted radially between the second inner bearing surface and the second outer bearing surface; the first bearing and the second bearing being blocked axially with respect to said rotary part respectively in at least a first direction and a second direction opposite to said first direction;
a preloading element configured to be able to be attached to the first part of the casing, in the first housing, in a plurality of preloading positions in which the preloading element exerts an axial preload on the first bearing in the first direction and the axial bearing surface of the second housing exerts an axial preload on the second bearing in the second direction; each preloading position corresponding to a different axial preloading value.

12. The transmission device as claimed in claim 11, wherein the preloading element is a cover which is inserted into the opening so as to close said opening.

13. The transmission device as claimed in claim 11, wherein the preloading element is a sleeve which is interposed radially between the first outer bearing surface and the first bearing and which comprises an axial bearing surface which is positioned in abutment against the first bearing on a side opposite to the opening.

14. The transmission device as claimed in claim 13, further comprising a cover closing the opening.

15. The transmission device as claimed in claim 12, wherein the cover comprises an annular skirt ensuring both the sealed closure of the opening and the preloading force.

16. The transmission device as claimed in claim 12, wherein the opening is larger than the first bearing and the housing, the cover comprising a first axial sealing skirt for sealingly closing the opening and a second axial preloading skirt, the second axial preloading skirt being situated radially inside the first axial sealing skirt.

17. The transmission device as claimed in claim 16, wherein the first part of the casing comprises an orifice situated radially between the housing and an edge of the opening and the cover comprising one or more passages connecting the orifice and the housing.

18. The manufacturing method as claimed in claim 3, wherein the first part of the casing comprises an orifice which passes through the wall of the first part of the casing in the vicinity of the housing and the cover comprises one or more passages to allow oil to circulate from the orifice to the housing, the cover being inserted into the opening while making the passage and the orifice coincide.

19. The manufacturing method as claimed in claim 3, wherein the cover has an aperture and wherein the cover supports a functional element selected from a temperature sensor, a drain plug, a magnet and an electrical connection device, said functional element being arranged in said aperture of the cover.

20. The manufacturing method as claimed in claim 3, wherein the cover further has a guide element for guiding a wire or a pipe.
